(19) United States
(12) Patent Application Publication
(10) Pub. No.: US 2006/0248529 A1
(43) Pub. Date: Nov. 2, 2006

(54) System and method for estimation of computer resource usage by transaction types

(76) Inventors: Charles Zdzislaw Loboz, West Ryde (AU); Dean Peter Harding, Seven NSW (AU); Jonatan Kelu, Granville NSW (AU)

Correspondence Address: UNISYS CORPORATION, UNISYS WAY, MAILSTOP E8-114, BLUE BELL, PA, 19424-0001, US

(21) Appl. No.: 10/540,950

(22) PCT Filed: Dec. 27, 2002
(86) PCT No.: PCT/US02/41622

§ 371 Date: Apr. 19, 2006

(51) Int. Cl. G06F 9/46

(52) U.S. Cl. 718/100

(57) ABSTRACT

The present invention provides a system (10) and method (30) for estimating computing resource usage (14) for each transaction type comprising the steps of obtaining utilisation data and transaction count data, applying a linear least squares algorithm (32) to the input data (22), wherein the linear least squares algorithm (32) comprises further steps arranged to reduce the time required to perform the aforementioned linear least squares algorithm computation.

### FIELD OF THE INVENTION

The present invention relates to a system and method for the estimation of computer resource usage by transaction types and specifically, but not exclusively, to a more computationally efficient method for estimation of resource usage by transaction types.

### BACKGROUND OF THE INVENTION

In a previous patent application filed by the applicant of the present patent application, a system and method were disclosed which enabled the estimation of computer resource usage by individual transaction types in a transaction processing system. In one embodiment of the invention disclosed in application PCT/09/110,000 filed on Mar. 14, 2002 at the United States Patent Office, there was disclosed a method which used a linear least squares algorithm to obtain resource usage estimates from log data. The log data included information on the number of transaction types and the amount of computer resource usage.

The method disclosed by the above mentioned patent application is comprised, in one embodiment, of the following steps:
a monitor in the computer system collects, periodically, information including computer resource usage statistics (CPU utilisation, disk utilisation, etc.) per given time interval and the number of transactions of each type executed in the given time period;
the collected information is converted to an appropriate form (if necessary);
a linear least squares algorithm is applied to the converted data to obtain resource usage estimates by solving the following matrix equation
   B=(X^{T}*X)⁻¹*(X^{T}*Y)
   where
B is the vector of estimates of the resource used for each transaction type, such as CPU usage per transaction
Y is a column vector, such as CPU-time
X is a rectangular matrix, such as the number of transactions of type “j” executed in the time interval “i”, and XT in the transpose of matrix X.

The method outlined above is commonly used offline (i.e. not in a “real world” situation), because the matrix equation can be computationally intensive and therefore may degrade performance in real world situations. This is caused, in part, by the large size of the matrices X and Y.

The size of the X and Y matrices will depend on the application and resource usage estimation requirements. The number of columns in the X array is equal to the number of transaction types. In real world systems, it is not uncommon for larger enterprise systems to have hundreds of transaction types. For example, an Enterprise Application Environment application such as UNISURE™ has over 1000 transaction types.

Similarly, the Y array represents the number of system characteristics, and generally, many large enterprise systems will contain hundreds of measurable system characteristics. These characteristics may include, for example, CPU time, disk seek time, number of interrupts, network packet throughput, the number of processes running on the system, etc. These characteristics may measure characteristics of the hardware (such as CPU time) or characteristics of the software (such as the number of processes running on the system).

Therefore, to obtain estimates of resource usage by transaction type, it is necessary to solve matrix equations with large matrices. Typically, such matrices may have thousands of rows and hundreds of columns, and in extreme cases, tens of thousands of rows and thousands of columns.

This may potentially require a large amount of system memory and a large amount of processor time, making the application of the technique not practical for certain “online” monitoring situations.

### SUMMARY OF THE INVENTION

In a first aspect, the present invention provides a method of estimating computing system resource usage for each transaction type, comprising the steps of,
obtaining utilisation data of a system resource for each resource type and transaction count data for each transaction type as input data, and
applying a linear least squares algorithm to the input data to provide an estimate of resource usage for an individual transaction type within the computing environment,
   wherein the application of the linear least squares algorithm comprises the further steps of,
providing a matrix, the size of the matrix being defined by the number of transaction types and the number of resource types,
storing the sum of the cross-products of each resource type and each transaction type in the matrix,
storing the sum of the cross-products of each transaction type with each other transaction type in the matrix, and
at selected time intervals, applying a further mathematical algorithm to derive an estimate of the resource usage per transaction type.

An advantage of the present invention is that the linear least squares method is preferably computed in a manner that reduces the number of operations required to provide a result.

Preferably, the method comprises the further step of dividing the computation into separate sub-parts.

A resource will be understood to mean any hardware or software component of a computing system which carries out a function. This may include a central processing unit (CPU), a disk drive or other persistent storage mechanism, or volatile memory. The preceding examples are given to illustrate some types of computing resources and should not be construed as limiting.

An embodiment of the present invention may be used in many situations where computing resource usage is scarce. For example, the method may be used in an “online” situation where a system administrator wishes to run an analysis whilst other transactions are being processed (i.e. a “live” situation).

As the cross-product computation is performed at every defined time interval, it is important to minimise the amount of computing time spent calculating cross-products.

It is only necessary to compute the cross-products of each resource counter with each transaction counter and each transaction counter with each other transaction counter.

This results in an appreciable “saving” of time and computing resources, as the number of operations that are performed is reduced. The magnitude of the saving depends on the ratio of the number of system counters to the number of transaction counters. This may be considerable if, for example, there are 100 transaction types but 500 system counters.

A transaction counter will be understood to mean any type of software application or hardware device arranged to count the total number of transactions executed or processed within a given interval of time.

Analogously, a system counter will be understood to mean any type of software application or hardware device or module arranged to “count” the resource utilisation of any hardware device or software application or module in a computing system.

Many commercial packages exist to perform such a function. For example, the Windows™ operating system includes a software module termed “perfmon”, which may be used to count or log the resource usage for any number of hardware or software sub-systems.

Preferably, the resource usage data includes a resource utilisation value for each resource type for each given time interval, and the transaction count data includes the total number of transactions executed for each transaction type in each given time interval.

Preferably, the number of calculations required to produce an estimate of resource usage by transaction type are reduced by computing a select number of cross-products from the total number of possible cross-products in the matrix.

Preferably, the mathematical algorithm is the Cholesky method.

In a second aspect, the present invention provides a system for estimating computing system resource usage for each transaction type, comprising,

means for obtaining utilisation data of a system resource for each resource type and transaction count data for each transaction type as input data, and
means for applying a linear least squares algorithm to the input data to provide an estimate of resource usage for an individual transaction type within the computing environment,
   wherein the means for the application of the linear least squares algorithm further comprises,
means for providing a matrix, the size of the matrix being defined by the number of transaction types and the number of resource types,
means for storing the sum of the cross-products of each resource type and each transaction type in the matrix,
means for storing the sum of the cross-products of each transaction type with each other transaction type in the matrix, and
   means for, at selected time intervals, applying a further mathematical algorithm to derive an estimate of the resource usage per transaction type.

In a third embodiment, the present invention provides a computing program arranged, when loaded on a computing system, to control the computing system to implement a method in accordance with the first aspect of the invention.

In a fourth aspect, the present invention provides a computer readable medium providing a computer program in accordance with a third aspect of the invention.

### DETAILED DESCRIPTION OF THE DRAWINGS

Features of the present invention will be presented in the description of an embodiment thereof, by way of example, with reference to the accompanying drawings, in which:

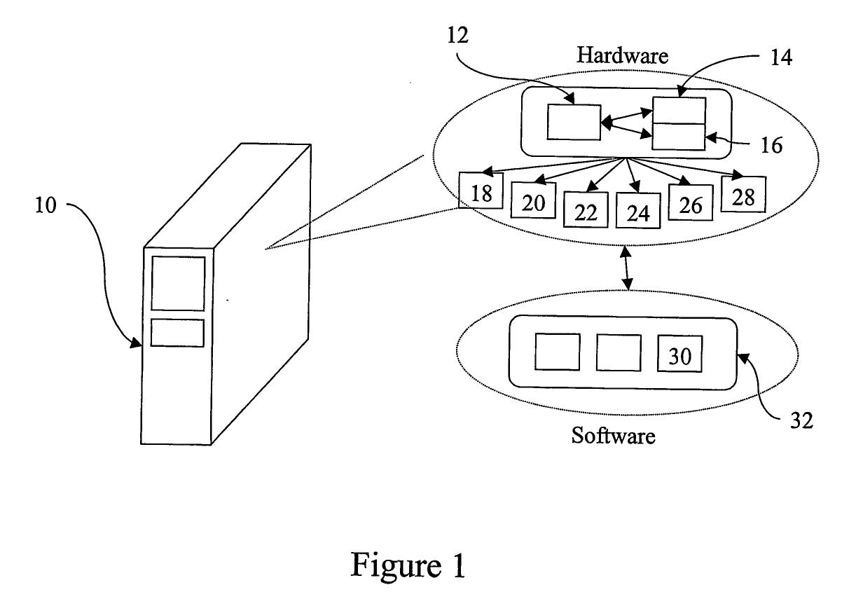

FIG. 1 illustrates a general-purpose computer that may be used to implement the present invention.

### DETAILED DESCRIPTION OF THE PREFERRED EMBODIMENT

At FIG. 1 there is shown a schematic diagram of a computing system 10 suitable for use with an embodiment of the present invention. The computing system 10 may be used to execute applications and/or system services such as deployment services in accordance with an embodiment of the present invention. The computing system 10 preferably comprises a processor 12, read-only memory (ROM) 14, random access memory (RAM) 16, and input/output devices such as disk drives 18, keyboard 22, mouse 24, display 26, printer 28, and communications link 20. The computer includes programs that may be stored in RAM 16, ROM 14, or disk drives 18 and may be executed by the processor 12. The communications link 20 connects to a computer network but could be connected to a telephone line, an antenna, a gateway or any other type of communications link. Disk drives 18 may include any suitable storage media, such as, for example, floppy disk drives, hard disk drives, CD ROM drives or magnetic tape drives. The computing system 10 may use a single disk drive 18 or multiple disk drives. The computing system 10 may use any suitable operating systems, such as Windows™ or Unix™.

It will be understood that the computing system described in the preceding paragraphs is illustrative only, and that an embodiment of the present invention may be executed on any suitable computing system, with any suitable hardware and/or software.

In one embodiment, the present invention is implemented as a software module 30, the module forming part of a larger suite of proprietary testing applications 32 that are provided under the name “NOFRTE”. NOFRTE is a computing system testing application, capable of testing Enterprise Application Environment applications on various different computing systems, including Windows™ and Unix™ platforms.

Examples of computing systems which can execute the NOFRTE package include the ES7000 and ES5000 range of Unisys servers. However, it will be understood that the present invention may be incorporated into any appropriate testing application, or any other software application, and may be arranged to be executed on any suitable computing system.

A method in accordance with one embodiment of the present invention will now be described. The embodiment hereinafter described utilises the same data as described in the applicant's earlier submission PCT/09/110,000, which is incorporated herein by reference.

The embodiment, termed the “computationally effective” method comprises the following steps:
1. a monitor in the computer system collects, periodically, information including computer resource usage statistics (CPU utilisation, disk utilisation, etc.) per given time interval and the number of transactions of each type executed in the given time period;
2. the collected information is converted to an appropriate form (if necessary);
3. a mathematical model, which in one embodiment is a linear least squares algorithm, is applied to the converted data to obtain resource usage estimates by solving the following matrix equation
   B=(X^{T}*X)⁻¹*(X^{T}*Y)

The above mentioned equation is a standard least linear squares algorithm, which may be found in many standard textbooks on statistics. One example is [Johnson et. al. Applied Multivariate Statistical Analysis 4^{th} edition, Prentice Hall, 1998].

In this equation, X represents a matrix containing the transaction count data, namely the number of transactions of type “j” executed in the time interval “i”, and Y represents a matrix containing the resource counter data, namely a variable such as, for example, the CPU time used in a given time interval.

The result, B, represents the average resource used per transaction type. For example, the average CPU time used by a particular transaction type.

The superscript ‘^{T}’ represents the transpose of the matrix (i.e. interchanging the rows and columns of the matrix), and the superscript ‘⁻¹’, represents the inverse of the matrix. Such terminology is known to a person skilled in the art.

The number of operations required to perform the preceding step (i.e. the application of the least squares algorithm to obtain resource usage estimates by transaction types) is reduced by employing the following intermediate steps when performing step 3 in the preceding sequence:
a square matrix CV is created in memory, to hold the computed sums of the crossproducts of the data vector;
at each time interval, the cross-product of the data vector is computed and stored in the matrix CV;
at selected time intervals, a solution to the CV matrix is computed using the Cholesky method.

The term “crossproduct” will be understood to mean a mathematical operation performed on a matrix. The term “crossproduct” is a term known in the art. See, for example, [Kreyszig, E., Advanced Engineering Mathematics, 7^{th} Ed. (1993, John Wiley & Sons, Inc.) Singapore)]

These steps are now described in more detail.

The module reserves a square matrix CV size N_{c} by N_{c} (where N_{c} in an arbitrary number representing the number of rows and columns in the square matrix CV) in memory, which may be volatile memory such as RAM, or virtual memory, such as disk space reserved by a operating system on a hard drive or other permanent memory device. The matrix stores all data required for future solutions of the equation. The matrix further collects the sums of cross-products of all data rows, (that is, the data rows themselves are not be stored).

The size of the storage matrix depends only on the number of transaction types and system variables (resources) that are measured.

Cross-product computation is performed at every defined time interval. In order to minimise the time cost associated with cross-product computation, at each time interval a row of data, N_{c} is delivered to the module in vector V. The vector, N_{c} is the sum of the number of transaction types and the number of system characteristics (for example, CPU time).

Vector V contains two types of values describing the system in the current interval:

system counters (such as, for example, CPU utilization, disk utilization, CPU usage by each process).
transaction counts—number of transactions of each type (and total) processed in this interval.

The software module performs the following operation (note that the following extract is pseudocode):

collect the sum of cross-products of V in CV

for c = 1 to Nc

for r = 1 to c

CV[r,c] = CV[r,c] + V[r] * V[c]

endfor

endfor

Note that, since V[r]*V[c]==V[c]*V[r], the matrix CV is symmetric. So, it is only necessary to compute the values in the upper triangular matrix only (in line 2 of the pseudocode r ranges from 1 to c, not to N_{c}). As only the upper triangular matrix is computed, preferably an appreciable amount of computing time is conserved.

The cost of cross-product computation may be reduced further. As stated above, the data vector V is comprised of two types of values, namely transaction counts and system resource counters. The applicant has discovered that it is not necessary to compute every cross-product.

For example, it is not necessary to compute cross-products between resource counters, as the cross-products between resource counters are not required for computation of the solution.

It is only necessary to compute the cross-products of each resource counter with each transaction counter. This results in an appreciable “saving” of time and computing resources, as the number of operations that must be performed is reduced. The magnitude of the saving depends on the ratio of the number of system counters to the number of transaction counters. This may be considerable if, for example, there are 100 transaction types but 500 system counters. Such values are reasonably common in modern enterprise transaction processing systems.

As described earlier, the equation to compute Linear Least Squares solution commonly used is
B=(X^{T}*X)⁻¹*(X^{T}*Y)
The CV matrix contains all the data required on the right hand side of this equation.
Selecting from the CV matrix a submatrix CVX, containing cross-products of transaction counts, the equivalent of the (X^{T}*X) matrix is obtained. Selecting from the CV matrix a row containing cross-products for, say, CPU time (i.e. CVY), the exact equivalent of the (X^{T}*Y) matrix is obtained. Thus, it becomes necessary to solve the equation
B=CVX⁻¹*CVY
Since CVX is a symmetric matrix, the Cholesky decomposition may be used to obtain a solution to the linear least squares equation with fewer operations than using algorithms designed for general matrices.
In addition, it is possible to code the Cholesky algorithm in such a way that it will use only the lower triangular part of the CV matrix. This leads to memory savings, as the CV matrix can be used for both storing data and computing the solution.
As stated, in one embodiment the computationally efficient method comprises two principal steps or stages:
the collection of cross-product sums
solving the matrix equation to obtain estimates of transaction resource usage
   Both steps outlined above use a combination of space and operation-count efficient methods to reduce overhead. The computational overhead is preferably further reduced by appropriate synchronisation of both methods—that is, by computing the solution only at selected time intervals, rather than at every time interval.
   In general it is not possible to save an appreciable amount of computer resources on the cross-product computation, as this data is collected at every interval. However, it is not necessary to solve the equation at every interval. Operational considerations dictate the length of the measurement interval and the applicant has found that the length of the measurement interval is generally quite low (approximately 1 second). However, system testers or system administrators (for systems in production) do not require resource usage estimates in one second intervals. Therefore, for systems in production and/or testing, the solution need only be computed every 30 seconds or in intervals of several minutes. It is also possible to compute the solution only when the tester (or system administrator) requires it.
   As stated earlier, there are potentially thousands of computer characteristics (system counters) residing on large servers. In real world systems, it is typical to have over 100 system counters which are critically important indicators of system performance, and which therefore must be collected. Some examples include disk load (from multiple disks), memory subsystem statistics, context switching, network behaviour, etc. Values of such counters are routinely collected and their average values displayed by system monitors or commercial monitoring packages. The system monitors are also used for the off-line analysis by the applicant's method (as disclosed in previous application PCT/09/110,000).
   For on-line analysis, not all system counters will be are equally important, because the goal of on-line analysis may be, say, to determine overall disk resource usage by transaction types, but not resource usage for each separate disk drive. Therefore, for the purpose of on-line analysis, the system administrator may reduce the number of system counters passed onto the on-line software module, to limit the module input to a handful of key system counters. This reduces the time required for estimates, but preserves the option for subsequent off-line analysis of all counters, based on the log file. Therefore, the computationally efficient method allows for on-line monitoring and display of analysis of transaction resource usage by:
splitting the total time required to compute the resulting values into smaller time components (cross-product computation and solution).
reducing the amount of memory required and the number of floating point operations required to perform the computations in each component.
reducing the number of times the computation of the solution is necessary.
   Therefore, in a system with 100-400 transaction types, both cross-product computation and solution computation preferably takes a fraction of a second of processor time. This is approximately equivalent to the time taken to process a single transaction. Since multiprocessor servers are generally capable of processing tens or hundreds of transactions per second, the overhead of the computationally efficient method is preferably relatively small. Systems with 500-1000 transaction types have larger, but preferably manageable overhead.
   In the aforementioned embodiment of the invention, the applicant has found that the memory required by the method is mostly that for the CV matrix, which computes to approximately N_{c}*N_{c}*8 bytes. Therefore, for a production system with 1000 variables, it is found that only 8 megabytes of memory are needed, which is a small amount of memory by multiprocessor server standards. In addition, this memory requirement does not depend on the time of the test (or production) run.
   In one embodiment, the invention is implemented as a software module in NOFRTE, a testing application, capable of testing EAE (Enterprise Application Environment) applications on all platforms. The NOFRTE package, and in particular the components related to resource usage are arranged to execute on a Windows based computing system. A simplified example of an embodiment of the present invention will now be described.

In this example, the data set will be comprised of CPU utilization statistics (hereinafter described by the variable name ‘CPU’) and three transaction types, namely “NewOrder” (NO), “StockLevel” (SL), and “Delivery” (DE). In each time period (at sampling time) there is collected a vector of length “four”—the first element contains the amount of CPU time used in the last interval, and the remaining three elements contain the number of transactions executed in that given time interval. A sample data file is shown below in Table I:

TABLE I
Sample Data File (CPU usage shown in seconds)

| | CPU (s) | NO | SL | DE |
|---|---|---|---|---|
| [1,] | 0.4996007 | 1 | 6 | 0 |
| [2,] | 0.4320437 | 5 | 2 | 6 |
| [3,] | 0.2707433 | 1 | 7 | 1 |
| [4,] | 0.1085788 | 4 | 5 | 2 |
| [5,] | 0.7396935 | 8 | 5 | 7 |
| [6,] | 0.4781680 | 1 | 0 | 4 |
| [7,] | 0.6870469 | 9 | 9 | 7 |
| [8,] | 0.5341712 | 9 | 3 | 6 |
| [9,] | 0.9123292 | 2 | 1 | 1 |
| [10,] | 0.9702378 | 6 | 7 | 2 |

(Note that the numbers presented in square brackets are for convenience only, they do not form part of the data).

Memory is reserved for a matrix CV, and all entries in the matrix are set to the value 0. Matrix CV collects the sum of the cross-products of data rows. Initially CV contains the following contents, as shown in Table II below:

TABLE II
Initial contents of matrix CV

| | CPU(s) | NO | SL | DE |
|---|---|---|---|---|
| [1,] | 0 | 0 | 0 | 0 |
| [2,] | 0 | 0 | 0 | 0 |
| [3,] | 0 | 0 | 0 | 0 |
| [4,] | 0 | 0 | 0 | 0 |

The cross-products of input data vectors are computed using the following algorithm (which is presented in pseudo-code):

for c = 1 to Nc

for r = 1 to c

CV[r,c] = CV[r,c] + V[r] * V[c]

endfor
endfor

where:

V is the row-vector of freshly arrived data. Thus, after the arrival of the first vector, the matrix CV contains the following data, as shown in table III:

TABLE III
Data in matrix CV after arrival of first vector

| | CPU(s) | NO | SL | DE |
|---|---|---|---|---|
| CPU | 0.2496009 | 0.4996007 | 2.997604 | 0 |
| NO | 0.0000000 | 1.0000000 | 6.000000 | 0 |
| SL | 0.0000000 | 0.0000000 | 36.000000 | 0 |
| DE | 0.0000000 | 0.0000000 | 0.000000 | 0 |

Note that the entries below the diagonal are computed, since the matrix is symmetric. Therefore, no additional information is derived from computing the lower half of the matrix.

After arrival of the second vector, it's cross-product with itself is added to the matrix CV resulting in the following content, shown in Table IV:

TABLE IV
Data after arrival of second vector

| | CPU(s) | NO | SL | DE |
|---|---|---|---|---|
| CPU | 0.4362626 | 2.659819 | 3.861692 | 2.592262 |
| NO | 0.0000000 | 26.000000 | 16.000000 | 30.000000 |
| SL | 0.0000000 | 0.000000 | 40.000000 | 12.000000 |
| DE | 0.0000000 | 0.000000 | 0.000000 | 36.000000 |

This process is continued, such that after arrival of the tenth vector, the matrix CV contains the elements shown in Table V below:

TABLE V
Data in CV matrix after arrival of ten vectors

| | CPU | NO | SL | DE |
|---|---|---|---|---|
| CPU | 3.828223 | 28.39764 | 25.48819 | 21.03785 |
| NO | 0.000000 | 310.00000 | 235.00000 | 230.00000 |
| SL | 0.000000 | 0.00000 | 279.00000 | 160.00000 |
| DE | 0.000000 | 0.00000 | 0.00000 | 196.00000 |

The final step in the process involves solving the equation by applying the Cholensky method. This operation is performed either ‘on request’ or periodically, after the arrival of a given number of data samples (in this example, after first 10 data samples/rows).
The CV array contains two types of data:

a) the first row, on positions 2 to 4 contains sums of cross-products of transaction counts with CPU usage—this is the vector CVY

| NO | SL | DE |
|---|---|---|
| 28.39764 | 25.48819 | 21.03785 |

b) rows 2 to 4 contain, on positions 2 to 4 cross products of transaction counts—this is the matrix CVX:

| | NO | SL | DE |
|---|---|---|---|
| NO | 310 | 235 | 230 |
| SL | 0 | 279 | 160 |
| DE | 0 | 0 | 196 |

To solve that system we need to compute the equation
B=CVX⁻¹*CVY

Computation of CVX⁻¹ can be done using Cholesky method as the matrix CVX is symmetric (see table VI below):

TABLE VI
Matrix CVX

| | NO | SL | DE |
|---|---|---|---|
| [1,] | 0.03990451 | 0.000000000 | 0.00000000 |
| [2,] | −0.01270512 | 0.010784260 | 0.00000000 |
| [3,] | −0.03645519 | 0.006105592 | 0.04289693 |

Multiplying B=CVX⁻¹*CVY, the sought solution expressing CPU usage by each transaction type (in seconds in this example) is obtained (See table VII below).

TABLE VII
Solution to equation

| | |
|---|---|
| NO | 0.04242459 |
| SL | 0.04252430 |
| DE | 0.02283830 |

The example given above presents a step-by-step solution using a highly simplified embodiment of the present invention. The example is merely illustrative of the two main steps necessary to reduce the number of operations required to apply the mathematical method. Further refinements to the basic method present in this embodiment are possible. These refinements will now be presented in more detail. The example given in the preceding paragraphs highlighted the fact that sections of the matrices remained unused. The primary motivation for not using the entire matrix was the reduction in processing time. It is not necessary to compute the entire matrix if only a portion of the matrix is required to compute the desired solution. However, this also provides memory savings, in addition to computational time savings.

Since the CV matrix is symmetric, it can be used for both data collection (the upper triangular part) and solution computation (lower triangular part). Note that the ‘conceptual’ CVX and CVY matrices are effectively submatrices of CV so no separate storage is required.

Hence all the operations may be performed using only the CV matrix with appropriate indexing. (Approach identical to that of standard pivoting can be used—by remapping indexes). In other words, there is no requirement to extract data from the CV matrix to the CVX and CVY matrices. It is sufficient to provide two additional index vectors, containing the indices of the X and Y data in the Cv matrix. These index vectors are then utilised when manipulation of the contents of the CV matrix is required. This approach is analogous to the approach used in the mathematical branch of numerical methods, such as the Gaussian method of solving a system of equations with pivoting. [see, Kreyszig, E., Advanced (Engineering Mathematics, 7^{th} ed. 1993, John Wiley and Sons, Inc., Singapore)].

The only overlap between data and solution matrices occurs on the diagonal. To avoid losing data a temporary store for the diagonal values must be implemented while the solution is computed. An additional vector for holding the diagonal can be declared and the diagonal data values can be copied to the additional vector before computation of the solution and copied back to the data matrix afterwards. Such an approach minimizes memory usage at the cost of additional memory copy operations. Note that the overhead of such operations is minimal, as it occurs only when the solution is computed.

When memory is not that critical, separate matrices can be used for data collection and solution, thus simplifying the coding of the algorithm. Note that the main memory gain is achieved by not keeping in memory the whole data matrix (containing thousands of rows), but just the CV matrix—all other memory gains are secondary. In addition, there is no need to compute explicitly the inverted matrix CVX⁻¹—as for all standard linear algebra algorithms it is possible to compute only the matrix factorization and solve the system by back substitution. Examples of this process are available in many undergraduate textbooks. For example, see [Strang, G., Introduction to Applied Mathematics, Wellesley-Cambridge Press, 1986].

Therefore, the present invention, in at least one embodiment, provides a method and system for on-line estimation of resource usage by transaction type. That is, one advantage of the invention is the ability to provide instantaneous statistics on resource usage by transaction type. This is useful because it may allow a system administrator or programmer to study comparting system behaviour in real time, and potentially make changes to the computing system “on the fly”. In the prior art, such analysis was generally performed “off-line”, as the amount of computing resources required to compute a solution did not make the technique practical for on-line use, especially where high load demands from other transaction requests are concurrently placed on the transaction processing system.

Moreover, in at least one embodiment, the present invention utilises less CPU resources than prior art methodologies, and also requires less volatile memory than prior art methodologies. Both these characteristics contribute to the usefulness of the technique in “on-line” computing systems, where such resources are generally scarce, especially in transaction processing systems which process a large amount of transactions. For example, a 5% increase in total system load may be deemed as unacceptable by a system administrator, especially, if the load is caused by what is deemed to be a “non-essential” software application. However, a smaller 1% increase in total system load may be acceptable in certain circumstances. In some embodiments (depending on the type of hardware and software that comprises a computing system), such small increase in load are achievable with an embodiment of the present invention.

Modifications and variations as would be apparent to a skilled addressee are deemed to be within the scope of the present invention.

1. A method of estimating computing system resource usage for each transaction type, comprising the steps of,
obtaining utilisation data of a system resource for each resource type and transaction count data for each transaction type as input data, and
applying a linear least squares algorithm to the input data to provide an estimate of resource usage for an individual transaction type within the computing environment,
wherein the application of the linear least squares algorithm comprises the further steps of,
providing a matrix, the size of the matrix being defined by the number of transaction types and the number of resource types,
storing the sum of the cross-products of each resource type and each transaction type in the matrix,
storing the sum of the cross-products of each transaction type with each other transaction type in the matrix, and
at selected time intervals, applying a further mathematical algorithm to derive an estimate of the resource usage per transaction type.

2. A method in accordance with claim 1, comprising the further step of dividing the computation into separate sub-parts.

3. A method in accordance with claim 1 or claim 2, wherein the utilisation data includes a resource utilisation value for each resource type for each given time interval, and the transaction count data includes the total number of transactions executed for each transaction type in each given time interval.

4. A method in accordance with claim 2 or claim 3, wherein the number of calculations required to produce an estimate of resource usage by transaction type are reduced by computing a select number of cross-products from the total number of possible cross-products in the matrix.

5. A method in accordance with claim 4, wherein the mathematical algorithm is the Cholesky method.

6. A system for estimating computing system resource usage for each transaction type, comprising,
means for obtaining utilisation data of a system resource for each resource type and transaction count data for each transaction type as input data, and
means for applying a linear least squares algorithm to the input data to provide an estimate of resource usage for an individual transaction type within the computing environment,
wherein the means for the application of the linear least squares algorithm further comprises,
means for providing a matrix, the size of the matrix being defined by the number of transaction types and the number of resource types,
means for storing the sum of the cross-products of each resource type and each transaction type in the matrix,
means for storing the sum of the cross-products of each transaction type with each other transaction type in the matrix, and
means for, at selected time intervals, applying a further mathematical algorithm to derive an estimate of the resource usage per transaction type.

7. A system in accordance with claim 6, further comprising means for dividing the computation into separate sub-parts.

8. A system in accordance with claim 6 or claim 7, wherein the utilisation data includes a resource utilisation value for each resource type for each given time interval, and the transaction count data includes the total number of transactions executed for each transaction type in each given time interval.

9. A system in accordance with claim 7 or claim 8, wherein the number of calculations required to produce an estimate of resource usage by transaction type are reduced by computing a select number of cross-products from the total number of possible cross-products in the matrix.

10. A system in accordance with claim 9, wherein the mathematical algorithm is the Cholesky method.

11. A computing program arranged, when loaded on a computing system, to control the computing system to implement the method of any one of claims 1 to 5.

12. A computer readable medium providing a computer program in accordance with claim 11.
